(19) United States
(12) Patent Application Publication
(10) Pub. No.: US 2004/0255232 A1
(43) Pub. Date: Dec. 16, 2004

(54) Networked presentation system

(75) Inventors: Kristian Hammond, Chicago, IL (US); Lawrence A. Birnbaum, Evanston, IL (US); Samuel Thomas Benediktson, Tulsa, OK (US); James W. Durkin III, Evanston, IL (US); Mario Jobbe, Homewood, IL (US); Leon X. Zhao, Waltham, MA (US)

Correspondence Address: McDERMOTT, WILL & EMERY, 600 13th Street, N.W., Washington, DC, 20005-3096, US

(73) Assignee: NORTHWESTERN UNIVERSITY

(21) Appl. No.: 10/458,284

(22) Filed: Jun. 11, 2003

(51) Int. Cl. G06F 15/00

(52) U.S. Cl. 715/500

(57) ABSTRACT

A networked presentation system manages transmission of presentation units to the audience, and ensures that the presentation units are displayed to, or accessible by, the audience in the same sequence as the presenter intends. The networked presentation system includes a presenter system, a presentation server and at least one audience system that connect to each other using a data transmission network. The networked presentation system controls to deliver the active presentation unit to the audience systems such that whenever the presenter renders one presentation unit active, the networked presentation system makes the active presentation unit available to the audience system. The networked presentation system allows users of the audience system to configure the way the presentation units are displayed on the audience system, and to attach notes to the presentation units. In addition, the networked presentation system may obtain feedback from the audience with respect to a specific presentation unit and calculate various indices representing the audience's responses based on the feedback. The networked presentation system may allow the presenter to access notes taken by the audience during the presentation in connection with a specific presentation unit. The networked presentation system may allow users to share notes with other people.

### FIELD OF THE DISCLOSURE

The present disclosure generally relates to a machine-implemented interactive presentation system, and more specifically, to a networked presentation system that provides synchronous and/or asynchronous data exchange and information sharing between data processing systems used by a presenter and the audience.

### BACKGROUND OF THE DISCLOSURE

Conventional presentations often involve using projectors and notebook computers to show slides to the audience. A presenter may use a laptop computer that utilizes presentation software applications, such as PowerPoint, to show slides that include figures, documents, and/or multimedia clips, etc. The audience may take notes using their own computers, tablet PCs, and/or PDAs (personal digital assistant) while the slides are projected on a big screen.

However, since the notes are taken separately from the slides, the notes would potentially lose their context when they are reviewed at a later time without access to the slides. Although the presenter may provide paper handouts of the slides presented in the presentation or class, the audience cannot integrate their notes on their computers with the printed slides. Even if the presenter may distribute electronic copies of the slides to the audience, it is still difficult for the audience to integrate the notes with the electronic files of the slides.

In addition, during the presentation, it is difficult for the presenter to effectively receive feedback from the audience regarding a specific slide or subject matter conveyed by the slides. Unless the audience ask questions, it is difficult for the presenter or professor to detect and/or pin point confusion from the audience, and provide further explanation directed to the slide or subject matter that causes confusion.

Therefore, there is a need to provide an interactive presentation system that allows the audience to effectively and/or efficiently access the slides while taking notes. There is also a need to automatically integrate the notes with the slides. There is another need for a networked presentation system that connects data processing systems used by a presenter and the audience to provide synchronous and/or asynchronous data exchange and information sharing between the presenter and the audience as well as between members of the audience. There is also a need to obtain information related to real-time feedback from the audience regarding a specific slide or subject matter presented by the presenter. There is an additional need to obtain information related to audience reaction with respect to a specific topic or subject matter. There is also a need to link the notes taken by the audience or the students with the slides presented. Moreover, there is another need for a distance learning and/or presentation system that allows the presenter or professor to collect and view students/audience feedback in real time. There is also a need to assess the overall effectiveness of presentations based on real-time response from the audience.

### SUMMARY OF THE DISCLOSURE

The concepts disclosed herein address the above noted needs as well as other needs and problems. More specifically, this disclosure describes a networked presentation system that connects data processing systems used by a presenter and audience to provide synchronous and/or asynchronous data exchange and information sharing between the presenter and the audience as well as between members of the audience.

A networked presentation system according to this disclosure allows a presenter to conduct a presentation that shows one or more presentation units to members of the audience in the same presentation sequence. A presentation unit is a unit of presentation that the presenter wishes to show to the audience. Each presentation unit may be identified by a unique presentation unit ID. A presentation unit may include one or more slides, documents, tables, moving pictures, photos, audio files, video files, multimedia files, and/or any combinations thereof, and any other types of files or presentations that the presenter wishes to show to the audience. A presentation unit can be a single file or an aggregation of several files.

The networked presentation system manages transmission of the presentation units to the audience and ensures that the presentation units are displayed to, or accessible by, the audience in the same sequence as the presenter intends. In one aspect, the audience and the presenter may be in the same room or location. In another aspect, the audience may also be remote to the presenter.

The exemplary networked presentation system includes a presenter system, a presentation server and at least one audience system that connect to each other using a data transmission network. The presentation server may be a server computer or a plurality of server computers that are accessible by, and in communication with, the presenter system and the audience system. A presenter system and an audience system are data processing systems that are used by a presenter or an audience, respectively. Various types of data processing systems may be used as the presenter system and the audience system, such as desktop computers, notebook computers, handheld computers, tablet PCs or the like.

Identities of the presenter and the audiences can be identified based on, for example, user IDs when users use their data processing systems to connect to and log into the presentation server. Software programs are used to control and coordinate the operation of the networked presentation system. The program code may be initially stored in a machine-readable medium and then read into the networked presentation system.

During a presentation, the presenter renders one or more presentation units active based on a predetermined sequence or by control of the presenter. The active presentation unit or units may be displayed in an active area, such as a specific window, of the display of the presenter system. In addition, the networked presentation system controls delivery of the active presentation unit to the audience systems such that whenever the presenter renders one presentation unit active, the active presentation unit is available to the audience system.

An exemplary networked presentation system according to this disclosure may allow users of the audience systems to configure the way the presentation units are displayed on the audience systems, and to attach notes to the presentation units. In addition, the exemplary networked presentation system may obtain feedback from the audience with respect to a specific presentation unit or subject matter conveyed by the specific presentation unit. The networked presentation system may calculate various indices representing the audience's responses based on the feedback from the audience.

The audience systems may be configured to display each presentation unit as soon as it arrives. In another example, the audience systems may be set to allow users to view any presentation unit as long as they want. If a new presentation unit arrives from the presentation server, an indication, such as a clickable arrow, is displayed on the user interface indicating that the presenter has just displayed a new presentation unit. The users of the audience systems may continue to view the current presentation unit or may choose to view the new presentation unit. Various arrow buttons may be provided to take the user to different presentation units that arrive after the current presentation unit. For instance, a first clickable arrow may be used to display presentation units arriving after the current presentation unit, and a second clickable arrow may be used to display the most recent presentation unit presented by the presenter.

The networked presentation system allows a user of the audience system to take notes for a specific presentation unit displayed on the audience system. In one aspect, the notes are sent back to the presentation server. If preferred, the audience system may maintain a copy of the notes. The presentation server maintains a database for notes taken by the users. The notes may be linked to at least one of the following attributes: title of the presentation, time of the presentation, user ID, the presentation unit ID of the presentation unit for which the notes are taken, etc. Users of the networked presentation system may access their notes after the presentation. In one aspect, the audience system may display the notes along with the presentation unit for which the notes are taken.

The networked presentation system may allow the presenter to access notes taken by the audience in connection with a specific presentation unit. The networked presentation system may allow users to share notes with other people. For example, user A may indicate to the presentation server that he would allow user B to view his notes for a specific presentation. In response, the presentation server allows user B to access and/or view presentation units and notes taken by user B as well as user A. The networked presentation system may implement a mutual note sharing system that allows a user to grant permission to allow others to view his notes only if the others also agree to allow the user to view their notes. A user may add any new note sharing arrangement or withdraw his consent to share notes for any presentation with any other people at any time.

Additional aspects and advantages of the present disclosure will become readily apparent to those skilled in this art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 shows the architecture of an exemplary networked presentation system.

FIG. 2 is a block diagram of an exemplary data processing system that may be used to implement the networked presentation system.

FIG. 3 is a block diagram showing a more detailed architecture of the networked presentation system.

FIG. 4 shows an exemplary process for delivering slides to students of the class.

FIG. 5 depicts an exemplary user interface for a student to view slides presented by a professor during a Computer Organization class.

FIG. 6 is an exemplary statistics table shown to the professor after the Computer Organization class, in which the numbers of confusion and interest for each slide presented in the class.

FIG. 7a shows an exemplary questionnaire sent to students.

FIG. 7b is a sample report generated based on student's response to the questionnaire.

FIG. 8 is a screenshot showing a user interface used by the professor to view slides and notes taken by students in connection with the slides.

FIG. 9 is an exemplary user interface that a student uses to view slides and notes prepared by himself as well as other students in the context of the presentation units to which each note pertains.

### DETAILED DESCRIPTION OF THE DISCLOSURE

In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

System Architecture

A networked presentation system according to this disclosure allows a presenter to conduct a presentation that includes one or more presentation units to a plurality of users at the same time. A presentation unit is a unit of presentation that the presenter wishes to show to the audience, and is identified by a unique presentation unit ID. A presentation unit may include one or more slides, documents, tables, moving pictures, photos, audio files, video files, multimedia files, and/or any combinations thereof, and any other types of files or presentations that the presenter wishes to show to the audience. A presentation unit can be a single file or an aggregation of several files.

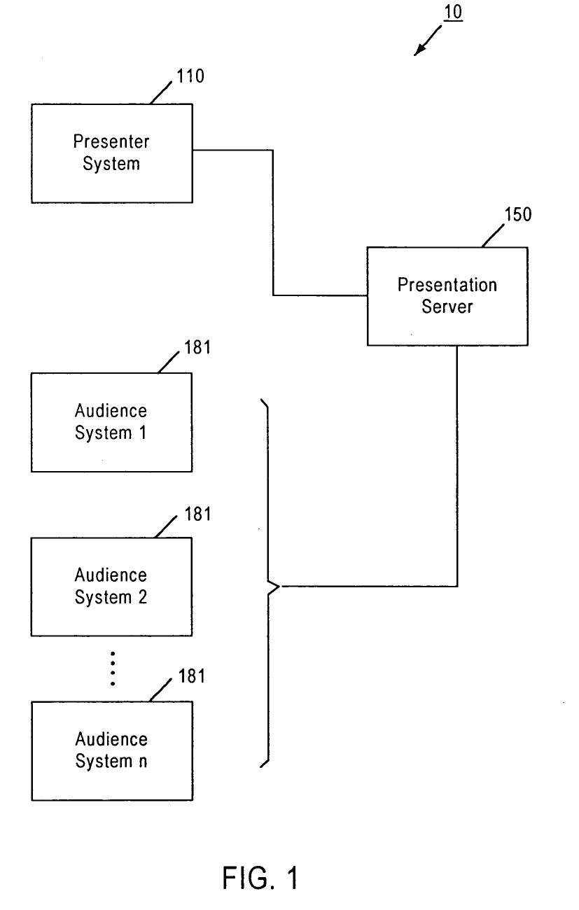

The networked presentation system manages transmission of the presentation units to the audience, and ensures that the presentation units are displayed to, or accessible by, the audience in the same sequence as the presenter intends. FIG. 1 shows the architecture of an exemplary networked presentation system 10 including a presenter system 10, a presentation server 150 and at least one audience system 181. The presenter system 110 and the at least one audience system 181 (audience system 1 to system n) connect to the presentation server 150 via a data transmission network, such as internet, LAN (local area network), or the like, by wire or wirelessly or both. The presentation server 150 is a server computer or a plurality of server computers that are accessible by, and in communication with, the presenter system 110 and the audience systems 181.

A presenter system and an audience system generally mean data processing systems that are being used by a presenter or an audience, respectively. Various types of data processing systems can be used as the presenter system and the audience system, such as desktop computers, notebook computers, handheld computers, tablet PCs or the like.

User identities of the networked presentation system can be determined based on user IDs that are used to log on the presentation server 150. A computer may be a presenter system when a user uses a presenter ID to log on the presentation server and conduct presentations. At a later time, the same computer may become an audience system if another user uses the computer to log on the presentation server with an audience ID. In one embodiment, one or more computers can be designated as a presenter system that are used exclusively by a presenter for conducting a presentation.

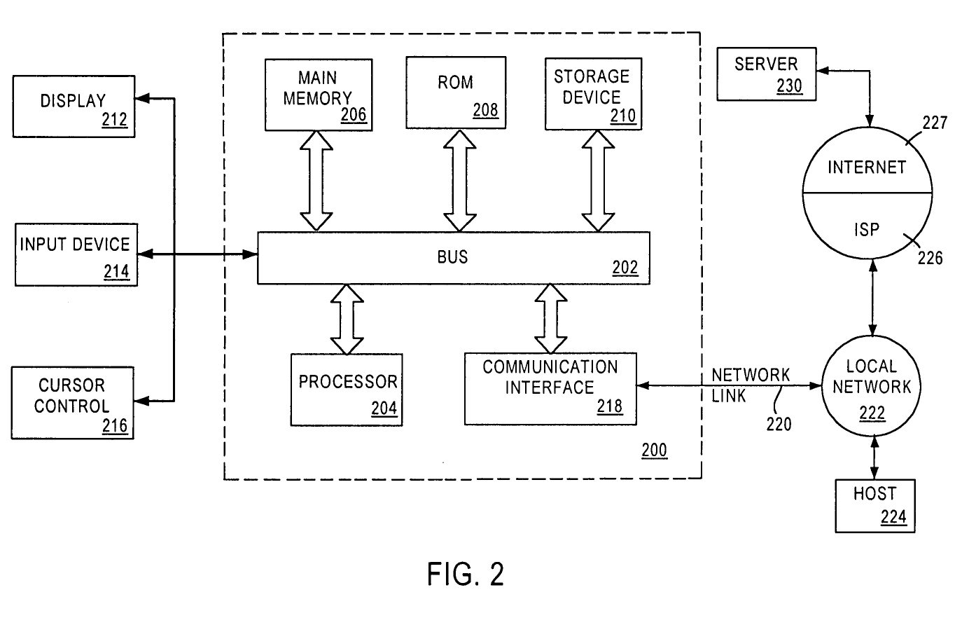

FIG. 2 shows a block diagram of an exemplary data processing system that can be used to implement the networked presentation system 10. The data processing system 200 includes a bus 202 or other communication mechanism for communicating information, and a data processor 204 coupled with bus 202 for processing data. Data processing system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by data processor 204. Data processing system 200 further includes a read only memory (ROM) 208 or other static storage device coupled to bus 202 for storing static information and instructions for processor 204. A storage device 210, such as a magnetic disk or optical disk, is provided and coupled to bus 802 for storing information and instructions.

The data processing system 200 may be coupled via bus 202 to a display 212, such as a cathode ray tube (CRT) or liquid crystal display (LCD), for displaying information to an operator. An input device 214, including alphanumeric and other keys, is coupled to bus 202 for communicating information and command selections to processor 204. Another type of user input device is cursor control 216, such as a mouse, a trackball, or cursor direction keys and the like for communicating direction information and command selections to processor 804 and for controlling cursor movement on display 212.

The data processing system 200 is controlled in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the disclosure. Thus, embodiments of the disclosure are not limited to any specific combination of hardware circuitry and software.

The term “machine readable medium” as used herein refers to any medium that participates in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio wave and infrared data communications.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 204 for execution. For example, the instructions may initially be carried on a magnetic disk of a remote data processing system, such as a server. The remote data processing system can load the instructions into its dynamic memory and send the instructions over a telephone line using a modem. A modem local to data processing system 200 can receive the data on the telephone line and use an infrared transmitter to convert the data to an infrared signal. An infrared detector can receive the data carried in the infrared signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Data processing system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host data processing system 224 or to data equipment operated by an Internet Service Provider (ISP) 226. ISP 226 in turn provides data communication services through the world large packet data communication network now commonly referred to as the Internet 227. Local network 222 and Internet 227 both use electrical, electromagnetic or optical signals that carry digital data streams. The signals through the various networks and the signals on network link 220 and through communication interface 218, which carry the digital data to and from data processing system 200, are exemplary forms of carrier waves transporting the information.

Data processing system 200 can send messages and receive data, including program code, through the network(s), network link 220 and communication interface 218. In the Internet example, a server 230 might transmit a requested code for an application program through Internet 227, ISP 226, local network 222 and communication interface 218.

The data processing also has various signal input/output ports (not shown in the drawing) for connecting to and communicating with peripheral devices, such as USB port, PS/2 port, serial port, parallel port, IEEE-1394 port, infra red communication port, etc., or other proprietary ports. The measurement modules may communicate with the data processing system via such signal input/output ports.

Software programs are used to control and coordinate the operation of the networked presentation system 10. The program code may be initially stored in a machine-readable medium and then read into the storage device 210. Alternatively, the program code may be initially stored in a server remote to the data processing system 200, and is then downloaded into the storage device for execution by the data processor 204.

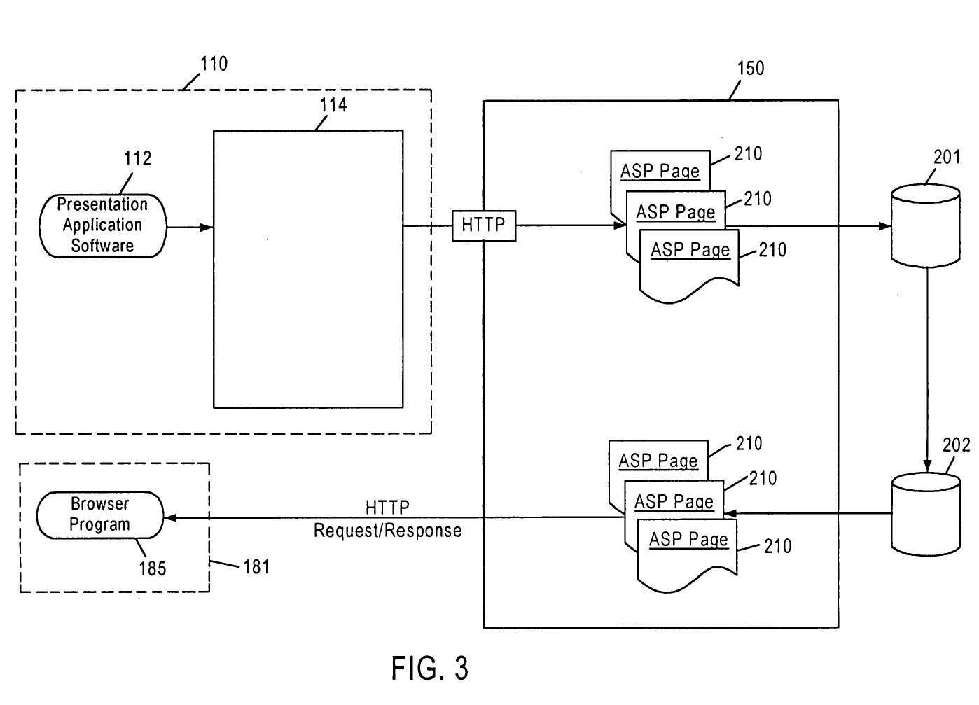

FIG. 3 is a block diagram showing a more detailed architecture of the networked presentation system 10. The presenter uses the presenter system 110 to conduct a presentation. The presenter system 110 is configured to execute presentation application software 112, such as PowerPoint, ACDsee, PhotoImpact, etc. The presenter utilizes the presentation application software 112 to compile and control display of presentation units. The presentation units can be arranged in a predetermined or random sequence or both, as the presenter sees fit. If preferred, the presenter may connect a projector (not shown) to the presenter system 110 to project the presentation units on a projection screen. The presenter system 110 also executes or has access to a control program 114.

In operation, the presenter uses the presentation application software 112 to render one or more presentation units active in a predetermined sequence or by manual control of the presenter. An active presentation unit is a presentation unit that the presenter wishes the audience to see. For example, in a conventional presentation, the presenter renders a slide active by placing the slide on a projector such that the slide can be displayed on the projection screen.

For some presentation application software, such as PowerPoint, the presenter renders a presentation unit active by causing the presentation unit to be displayed in an active area, such as a specific window. Once a presentation unit is rendered active by the presenter, the networked presentation system 10 makes the active presentation unit accessible by the audience system 181. The process of delivering active presentation units to the audience system 181 will be discussed shortly.

The presenter system 110 includes, or has access to, a control program 114 that monitors the operation of the presentation application software 112. The control program 114 keeps track of active presentation units, and constantly communicates with the presentation server 150 regarding the active presentation unit being displayed on the presenter system 110. The control program 114 may be part of the presentation application software 112, or an add-in program or software object corresponding to the presentation application software 114 and/or other application software that may be used by the presenter to conduct the presentation. According to one embodiment, whenever the presenter launches presentation application software 112, the corresponding control program 114 is also launched to monitor the operation of the presentation application software 112 and communicate with the presenter server. According to another embodiment, the control program 114 is launched manually by the presenter, such as by pushing a specific button or clicking a specific icon.

The control program 114 may be implemented using COM (component object model) add-ins. COM is a component software architecture that defines a structure for building program routines (objects) that can be called up and executed. COM objects may be written in several programming languages, and can perform any kind of processing. The presentation application software 112 or other application software programs can call the COM objects, and can invoke COM objects, called “controls,” that blend in and become just another part of the software program. Objects can be run remotely over the data transmission network in a distributed environment. Application programs can be written to expose their internal functions as COM objects, allowing them to be “automated” instead of manually selected from a menu.

During the presentation, the control program 114 continuously monitors activities of the presentation application software 112 and keeps track of presentation units being rendered active on the presenter system 110. The control program 114 then conveys information related the active presentation unit to the presentation server 150. For instance, when the presenter changes from a first slide to a second, the second slide is rendered active. The control program 114 keeps track of the presentation unit ID of the active presentation unit and transmits the presentation unit ID of the active presentation unit to the presentation server 150. Based on the information regarding the active presentation unit, in one embodiment, the presentation server 150 may control to have the active presentation unit delivered to the audience system 181. In another embodiment, the presentation server 150 maintains a presentation sequence of the presentation units being rendered active on the presenter system 110, and continuously conveys information related to the presentation sequence to the audience system 181 so that the audience system 181 can display the presentation units in the same presentation sequence.

The audience system 181 runs a web browser program 185, such as Internet Explorer or Netscape, to communicate and/or exchange information with the presentation server 150. The audience system 181 and/or the web browser may support protocols that enable a program to add functionality by calling ready-made components that blend in and appear as normal parts of a program, such as Microsoft's ActiveX component technology, Java or JavaScript by Sun, or the like.

The presentation server 150 executes server operating system programs, such as UNIX, Windows Server 2003, Windows NT, Linux, Sun Solaris, or the like. The presentation server 150 may access database systems that reside on one or more storage devices and/or database servers. The presentation server 150 also runs other programs, such as Microsoft Internet Information Services, for providing services related to ASP (active server page) or other similar protocols, such as CGI scripts and/or JavaServer Pages (JSPs), which allow Web pages to interact with databases and other programs. ASP is a Web server technology from Microsoft that allows for the creation of dynamic, interactive sessions. An ASP page is a Web page that contains HTML and embedded programming code written in certain program language like VBScript or Jscript. When the presentation server 150 encounters an ASP page requested by the browser residing on the audience systems 181 or other systems connected to the presentation server 150, the presentation server 150 executes the embedded program. The presentation server 150 also has access to a database system 201 and file system 202. The database system 201 may be a relational database system, such SQL (Structured Query Language) database system.

System Operation

The following examples are described using a teaching session as an example in which a professor uses the networked presentation system 10 to conduct a presentation in a classroom-like environment or settings. The networked presentation system 10 allows students to view slides presented by the professor and take notes. The students may be remote from the professor, or in the same room or physical location with the professor, or both. The networked presentation system 10 may be used to provide real-time long distance learning programs in which students at different locations may attend the same class and review slides presented by the professor despite their physical locations. It is noted that the use of the teaching session is for illustration purpose only. The same concepts can be applied to other types of presentations.

As an example, in a Computer Organization class, the professor of the class uses a professor ID and a computer to connect to and log on the presentation server 150 as a professor for the Computer Organization class. The professor's computer now works as the presenter system 110. Students of the Computer Organization class may use their own computers and student IDs to connect to and log on the presentation server 150 as students of the Computer Organization class. The students' computers now work as audience systems 181. The presenter system 110, the presentation server 150 and the audience systems 181 have the hardware and/or software architecture as described earlier in the system architecture section.

When the professor and the students log on the presentation server 150, the presentation server 150 checks if there is any active session (in this case the Computer Organization class) for these users based on information embedded in their login IDs and/or the information submitted by the users during a logon process. If the presentation server 150 determines that an active session is available for the user, the presentation server 150 controls the audience system/presenter system to launch proper software program to attend the active session. On the other hand, if there is no active session available for the user, the presentation server 150 controls the audience system/presenter system to launch proper software program for after-presentation functions. Detailed descriptions of the after-presentation functions will be discussed shortly. Since the Computer Organization class is active when the professor and the students logged on the presentation server 150, proper software programs are launched on the presenter system 110 and the audience systems 181 for the Computer Organization class.

The professor uses PowerPoint to create, compile, and arrange slides to be presented in the Computer Organization class. Other software applications can also be used depending on the professor's preference. The slides are presented in any sequence and/or pace desired by the professor. For example, the professor may select and/or create slides during the class, and present the slides randomly as she sees fit. Or, the professor may select slides for the Computer Organization class before the class and arrange to have the selected slides displayed in a predetermined presentation sequence. Also, the professor may initially present the slides in a predetermined presentation sequence, and then introduce additional slides other than those in the predetermined presentation sequence, and then resume to the predetermined presentation sequence.

According to one embodiment, the professor selects slides to be used in the Computer Organization class and then uploads these slides to the presentation server 150 before the class. According to another embodiment, the professor does not have to upload the slides she will use before every class. Instead, the professor uploads every slide she has to the presentation server 150 only once. After that, the professor only needs to upload slides to the presentation server 150 when she adds new slides or revises those slides that are already in the presentation server 150. According to a third embodiment, presentation units are uploaded to the presentation server 150 only as they are selected for presentation.

The slides may be converted to ASP pages and stored in the database system 201. Each slide has a unique presentation unit ID. Thus, when the Computer Organization class starts, the presentation server 150 has a complete copy of the slides that the professor may use during the class.

During the class, the professor uses the presenter system 110 to open her presentation file containing the slides that she will use in her class and starts her presentation. The slides are arranged in a presentation sequence. After the presentation file is opened, the presenter may hit a control button each time when she wants to render a slide active using the presentation sequence. The presenter may choose to render slides active by double clicking the file name of a slide or an icon representing a slide, or by dragging an icon representing a slide into a specific area. When the Computer Organization class starts, the professor renders slide No. 1 active by hitting a control button. Slide No. 1 is now rendered active and may be displayed in an active window of the presenter system 110.

The presenter system 110 executes a control program 114 implemented as a PowerPoint plug-in that monitors the operation of PowerPoint. During the presentation, the control program 114 controls the presenter system 110 to obtain information related to the slide being rendered active by the professor (in this case slide No. 1), and passes the information to the presentation server 150. Based on the information received from the control program 114, the presentation server 150 accesses the database system 201 to obtain a copy of slide No. 1. The presentation server then delivers the same to each of the audience systems 181 that connects to the presentation server 150 and has logged on the presentation server 150 for the Computer Organization class.

When the professor changes to the next slide, say slide No. 2, the professor renders slide No. 2 active by hitting a control button. In response, the control program 114 obtains information related to case slide No. 2 and passes the information to the presentation server 150. Based on the information, the presentation server 150 accesses the database system 201 to obtain a copy of slide No. 2 and delivers the same to each of the audience systems 181 that connects to the presentation server 150. The same process repeats each time when the professor renders a new slide active.

When the presentation server 150 delivers presentation units to the audience systems 181, the presentation server 150 may convert the presentation units or slides to proper format such that the presentation units or slides can be displayed properly on different types of audience systems 181, such as PDAs or cellular phones. The networked presentation system 10 may reformat the presentation units or slides for certain types of audience systems such that only a portion of the slides or presentation units are transmitted and/or displayed on certain types of audience systems 181. For certain types of audience systems 181 that have smaller display screens, such as PDAs or cellular phones, the presentation server 150 may extract only titles of the slides and send them to the audience systems. In one embodiment, the presentation server 150 may generate a representation of each slide, such as slide numbers or titles, and send them to the audience systems 181.

Information related to the types of audience systems 181 being used by the students can be determined by a handshaking process when the students logged on the presentation server 150 or by a configuration setting provided by the students. The presentation application software 112 may render the slides active using the predetermined presentation sequence without the intervention of the professor. In that case, the control program 114 still performs the same process as described above to convey information related to active slides to the presentation 150.

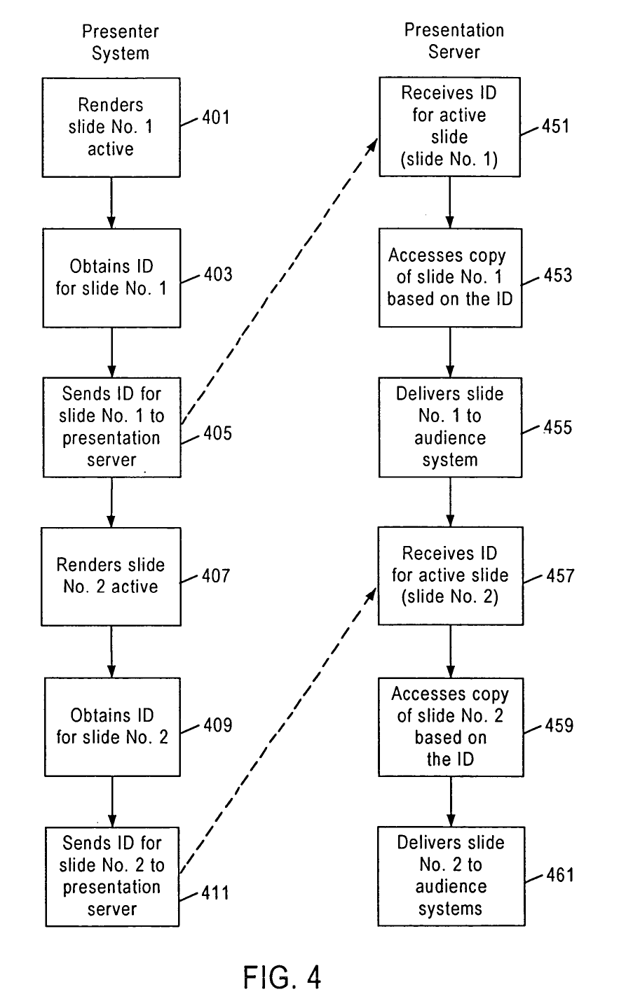

FIG. 4 shows an exemplary process for delivering slides to students of the Computer Organization class. In Step 401, the professor renders slide No. 1 active. The control program 114 on the presenter system 110 obtains the presentation unit ID corresponding to the slide No. 1 (Step 403) and conveys the presentation unit ID of slide No. 1 to the presentation server 150 (Steps 405 and 451). In Step 453, the presentation server 150 accesses the database system 201 to obtain a copy of slide No. 1 based on its presentation unit ID. The presentation system then sends a copy of slide No. 1 to the audience systems 181 (Step 455). The professor then renders slide No. 2 active (Step 407). The control program 114 detects the change of active slide, and obtains the presentation unit ID corresponding to slide No. 2 (Step 403) and delivers the ID to presentation server 150 (Steps 411 and 457). In response, the presentation server 150 accesses a copy of slide No. 2 from the database system 201 (Step 459), and delivers the same to the audience systems 181 connected to the presentation server 150 (Step 461).

The professor may render any slide active at any time as she wishes without a predetermined presentation sequence. Since the control program 114 keeps track of the slides being rendered active on the presenter system 110, information related to the identities of active slides is obtained and conveyed to the presentation server 150. The presentation server 150 in turn accesses the database system 201 to obtain copies of the active slides and transmits the same to the audience systems 181. As the presentation server 150 delivers copies of active slides to the audience system 181 in the same sequence as they are rendered active on the presenter system 110, the display sequence on the presenter system 110 and the audience system 181 are the same.

According to another embodiment, the operation of the presenter system 110 and the presentation server 150 are the same as those described above, except that the professor does not have to upload her slides to the presentation server 150 before the class. Instead, whenever a slide on the presenter system 110 is rendered active, the control program 114 conveys a copy of the active slide and its presentation unit ID to the presentation server 150 on the fly. In response, the presentation server 150 sends the active slide to the audience systems 181.

The slides sent to the audience system 181 are cached for display. Depending on sign preference, the audience system 181 may keep a copy of the slides as well as the presentation sequence of the slides for future access. Information related to the presentation unit ID for each slide is delivered to the audience system 181 by the presentation server 150.

In still another embodiment, the professor uploads her slides to the presentation server 150 in advance. Copies of the slides are sent to the audience system 181 along with their respective presentation IDs when the students log on the presentation server 150 during the class or even before the class starts. During the class, the control program 114 detects change of active slide on the presenter system 110 and conveys the presentation unit ID of the new active slide to the presentation server 150 as discussed above. The presentation server 150 in turn conveys the presentation unit ID of the new active slide to the audience system 181. The audience system 181 may access the new active slide based on the received presentation unit ID.

An exemplary networked presentation system according to this disclosure may allow users of the audience system 181 to configure the way the presentation units are displayed, and to attach notes to the presentation units. In addition, the networked presentation system may obtain feedback from the audience with respect to a specific presentation unit or subject matter. The networked presentation system may further calculate various indices representing the audience's responses based on the feedback.

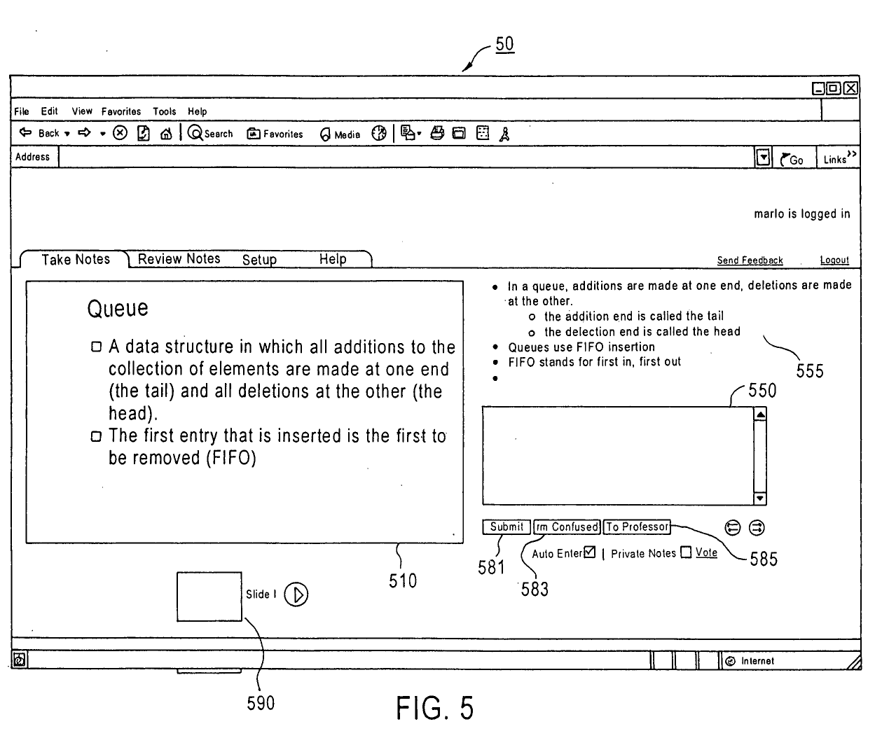

Continuing the example of Computer Organization class described above, FIG. 5 shows an exemplary user interface 50 for a student to view slides presented by the professor during the Computer Organization class. Slide 510 is a slide displayed on the student's audience system 181 that explains the concept “queue” in computer operation.

The networked presentation system 10 allows the students to configure the audience system 181 to display slides in different modes. For example, in one display mode, the audience system 181 is set to display each slide as soon as it arrives. In other words, when the presenter changes a new slide, the new slide is displayed on the audience system 181.

In another display mode, the audience system 181 may be set to allow the student to view the current slide as long as he wants. If a new slide arrives from the presentation server 150, a clickable icon 590 is displayed on the user interface 50 indicating that the professor just changed a new slide. The clickable icon may be a shrunk image of the new slide. Other representations that are used to identify slides can also be used, such as slide numbers, slide titles, or slide IDs.

The system may be configured to display clickable icons representing each of the slides that are rendered active on the presenter system 110. Whenever a new slide arrives, a shrunk image corresponding to the new slide is displayed. The system may be configured to display only the icon representing the most current slide.

The student may continue to view the current slide or choose to view the new slide by clicking the clickable icon 590 which will display the new slide to the student. Under this display mode, the presentation server 150 may constantly receive a status signal from the audience system 181 indicating the presentation unit ID of the slide being displayed on the audience system 181. If the presentation system 150 determines that the slide being displayed on the audience system 181 is different from the most current slide, the presentation server 150 generates a control signal to control the audience system to display an arrow button as described earlier. According to another embodiment, the comparison of the slide being displayed and the most current slide can be carried out by the audience system 181. The audience system 181 then sends a status signal to notify the presentation server 150. In response, the presentation server 150 generates a control signal to control the audience system to display an arrow button as described earlier. The new slide may be obtained from the cache memory of the audience system 181 or delivered from the presentation server 150 in response to the clickable icon 590 being clicked.

According to another example, various types of icons and/or arrow buttons may be provided to indicate arrivals of new slides and to allow students to access different slides that arrive after the current slide 510. For instance, a first clickable arrow may be used to display slides arriving after the current slide 510 in sequence, and a second clickable arrow may be used to display the most recent slide presented by the professor.

The networked presentation system 10 allows a student to take notes for a specific slide displayed on his audience system 181. Input window 550 allows the students to key in any notes he likes. In FIG. 5, three function buttons are provided underneath the input window 550. The student uses the Submit button 581 to submit any notes he types in the input window 550. Display area 555 shows the notes already submitted by the student with respect to the slide 510. In one embodiment, in response to the student hitting the Submit button 581, the audience system 181 sends the notes submitted by the student to the presentation server 150. The audience system 181 may maintain a copy of the notes on the storage device of the audience system 181.

The presentation server 150 maintains a relational database on the database system 201 for notes taken by students of the Computer Organization class. The notes are linked to or identified by name of the class (in this case Computer Organization), time of the class, student ID, and the presentation unit ID of the slide for which the notes are taken. The presentation server 150 allows students of the Computer Organization class to access their notes after the class. When a student requests access to his notes for Computer Organization, the presentation server 150 gathers his notes for Computer Organization along with respective slides to which the notes are linked, and sends them to the student. Since the notes are linked to their respective slides, the audience system 181 may display the notes along with the slides for which the notes are taken.

The networked presentation system 10 allows the students to send in their feedback in various ways. Referring to FIG. 5, the user interface 50 provides a “To Professor” button 585. The student may type any questions and/or comments that he wants to send to the professor in the input window 550, and clicks the “To Professor” button 585 to have them delivered to the presenter system 110. In response, the audience system 181 transmits the questions or comments to the presentation server 150 along with the presentation unit ID of the slide corresponding to the questions or comments. The presentation server 150 in turn delivers the questions or comments to the presenter system 110. The presenter system 110 may signal the arrival of the questions/comments and make the questions/comments accessible to the professor. For instance, the user interface on the presenter system 110 may provide a window for displaying questions/comments from students. If the presentation unit ID for the slide corresponding to the questions/comments are available, the presenter system 110 may allow the professor to access the slide corresponding to the questions/comments either automatically or manually, such as by clicking a control button.

In FIG. 5, the user interface 50 also provides an “I'm Confused” button 583. A student clicks the “I'm Confused” button 583 whenever he feels confused about a slide displayed on the audience system 181 or something said by the professor. In response, the audience system 181 sends a confusion signal to the presentation server 150. If preferred, other information related to the confusion signal, such as the time when the “I'm Confused” button 583 is clicked, the presentation unit ID of the slide from which the confusion arose, the student ID of the student who clicks the “I'm Confused” button 583, etc., is also collected and sent to the presentation server 150. Other feedback means other than the “I'm Confused” button and “To Professor” button can also be implemented depending on preference of system designs.

According to one embodiment, the presentation server 150 and/or the presenter system 110 keep track of the number of confusion signals sent by the students for a specific slide and/or during a specific period of time. A warning signal may be triggered if the number of confusion signals exceeds a predetermined threshold number or percentage, which signals that the students are confused or need further explanation for the specific slide. The level of threshold may be configured by the professor or preset by the networked presentation system 10. The presentation server 150 and/or the presenter system 110 may provide an indication representing the level of confusion, such as a visual indication bar dynamically showing the accumulated number of confusion signals for each slide.

In addition, the networked presentation system 10 may allow the professor to evaluate students' interests on a specific slide. For example, the students' interests on a specific slide may be determined based on their note-taking activities or the number of questions asked in connection with that specific slide. The presentation server 150 and/or the presenter system 110 may track the note-taking activity by calculating the number of notes taken by the students with respect to a specific slide. As discussed earlier, the students submit their notes in connection with a slide by clicking the “Submit” button 581. In response, the audience system 181 sends the notes as well as other information related to the note-taking activity, such as time when the notes are submitted, the presentation unit ID of the slide, the student ID, etc. to the presentation server 150. The number of questions asked by students may also be used to determine students' interest. As discussed before, the students may ask questions by clicking the “To Professor” button 585. The number of questions asked may be calculated in a way similar to that discussed relative to the note-taking activity. The presentation server 150 and/or the presenter system 110 thus can track the number of notes and/or questions sent from students to calculate indices related to students' interest with respect to a specific slide.

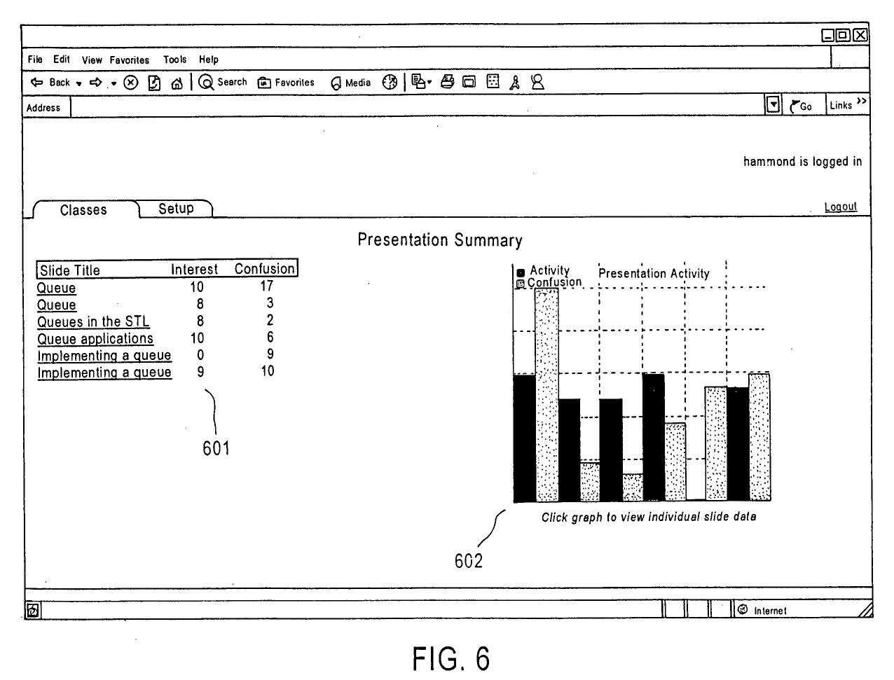

The networked system 10 may prepare and provide statistics to the professor after the class. FIG. 6 shows an exemplary statistic table 601 provided to the professor after the Computer Organization class. In the statistic report, the numbers of confusion and interest for each slide presented in the class are listed. A bar diagram 602 showing note-taking activities and the level of confusion is also provided.

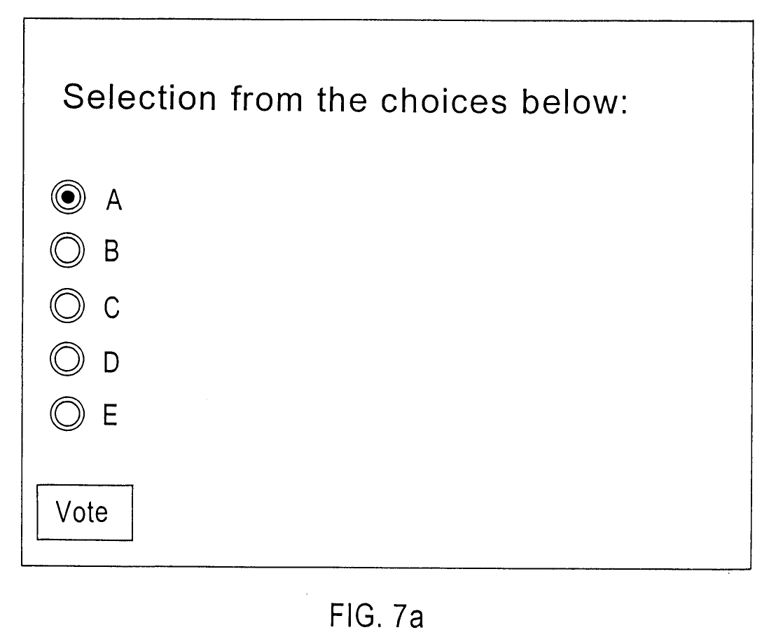

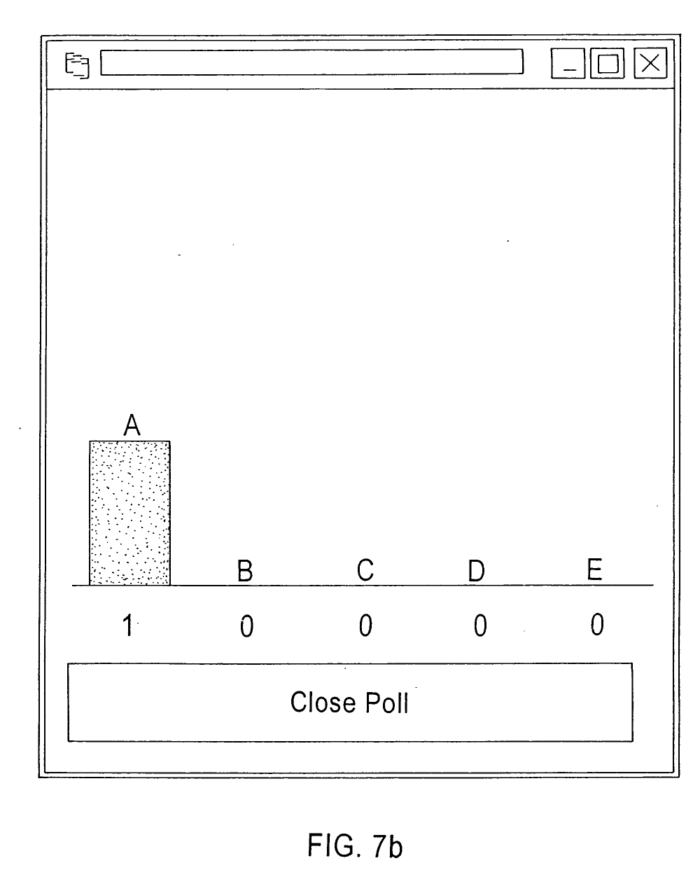

In addition, the networked presentation system 10 may provide a means to proactively solicit responses from students. For example, the professor may send a questionnaire to students to request their responses to a specific question. An exemplary questionnaire is shown in FIG. 7a. When the questionnaire arrives to the audience system 181, the student chooses an answer and clicks the Vote button to send the answer to the presentation server 150, which in turn sends the answer to the presenter system 110. The presentation server 150 and/or the presenter system 110 may collect the answers sent by the students and generate a report to the professor, such as that shown in FIG. 7b.

After-Presentation Operation

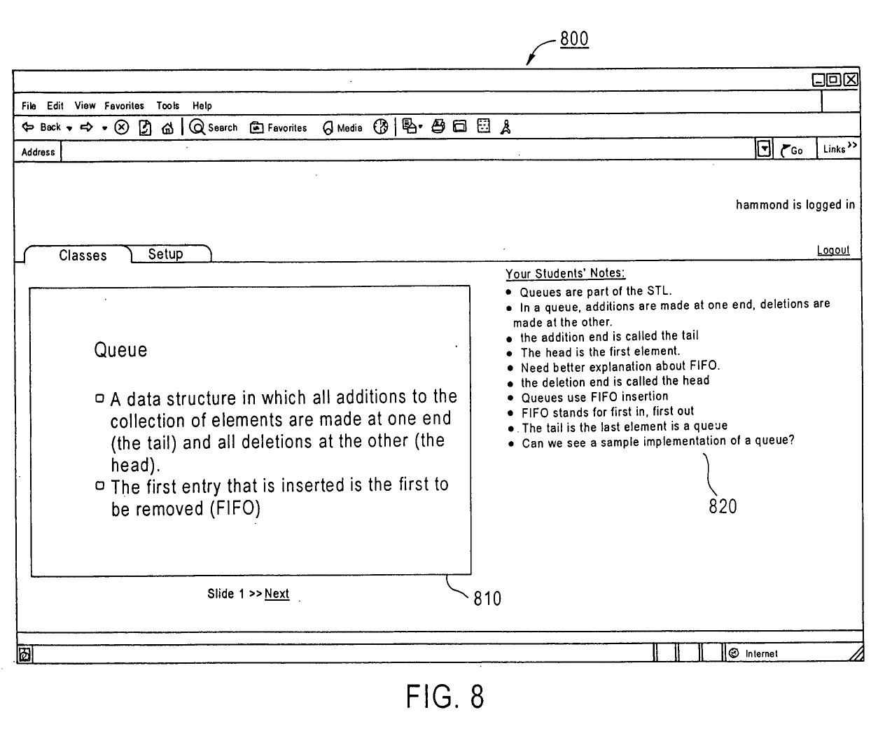

The networked presentation system 10 operates in an “after presentation” mode when there is no active presentation session for a user when he or she logs on the presentation server 150. The networked presentation system 10 provides various functions under the “after presentation” mode. For example, after the Computer Organization class, the networked presentation system 10 allows the professor to log on the presentation server 150 to access various statistical reports and/or indices as described earlier. The professor may also access notes taken by the students for the Computer Organization class. Since the presentation server 150 stores the students' notes in the database system 201 by linking the notes to the respective slide for which the notes are taken, the presentation server 150 may access the database system 201 to retrieve all notes linked to a specific slide. FIG. 8 is an exemplary screenshot showing a user interface 800 used by the professor to view slide 810 and notes 820 taken by the students in connection with slide 810 during the Computer Organization class. The professor may evaluate the effectiveness of the class based on students' notes. If preferred, the presentation server 150 may gather other information related to each slide presented in the class. For instance, the presentation server 150 may provide information related to the number of students attending the class, questions/comments submitted by students corresponding to each slide, levels of confusion during the class, etc.

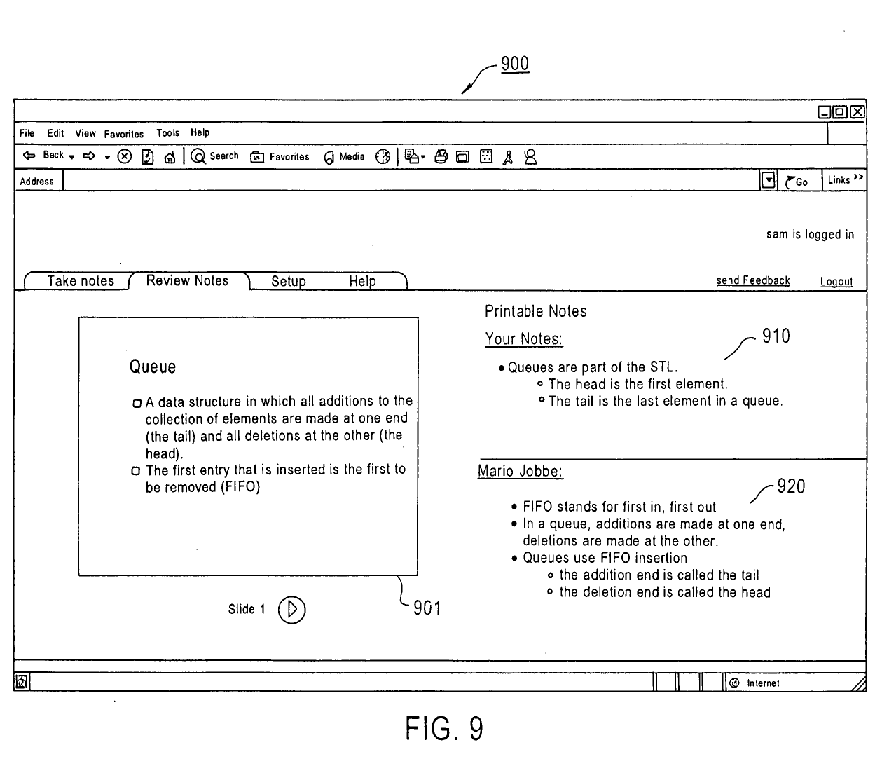

The networked presentation system 10 also allows a student to share notes with other students. For example, student A may indicate to the presentation server 150 that he would allow student B to view or access his notes for a specific class, such as Computer Organization. In response, the presentation server 150 creates a link in the database system 201 allowing student B to access student A's notes. When student B accesses his notes for the slide, student A's notes will also be shown. FIG. 9 is an exemplary user interface 900 that a student uses to view slide 901 and notes taken by the student as well as by other students in connection with slide 901.

A mutual note sharing system can be implemented in the networked presentation system 10. Mutual note sharing means that student A agrees to allow student B to view student A's notes only if student B also agrees to allow student A to view the notes taken by student B. In operation, when student A wishes to share notes for a specific class with student B under a mutual note sharing arrangement, student A may select student B from a student name list of the Computer Organization class. Student A may indicate that a mutual note sharing with Student B is desired by, for example, double clicking student B's name on the list or selecting a specific function button. In response, the audience system 181 of student A sends a request to presentation server 150 indicating that student A would like to initiate a mutual note sharing authorization process for a specific class involving student B. The presentation server 150 then generates and sends a signal to student B's audience system 181 indicating that a mutual note sharing request for Computer Organization class from student A has been initiated. The signal is sent to student B's audience system either immediately if the student B has logged on the presentation server 150, or at a later time when student B logs on the presentation server 150.

If student B agrees with the mutual note sharing request, student B may simply indicate as such by, for example, clicking an “Agree” button displayed on his system. In response, student B's audience system 181 sends a signal to presentation server 150 indicating that student B has consented to share notes for Computer Organization with student A under a mutual note sharing arrangement. The presentation server 150 then creates a link or links in the database system 201 allowing students A and B to access each other's notes for Computer Organization class. A student may add any new note sharing arrangement or withdraw his consent to share notes for any class with any student at any time. The student may change the settings on his audience system 181, which in turn send a signal to the presentation server 150 to change these settings.

The networked presentation system 10 may provide various additional functions/forums to assist and encourage communications and opinion sharing between the professor and the students and/or between the students. For example, the presentation server 150 may provide functions such as chat rooms, BBS (bulletin board system) and/or instant messaging for students and the professor to share their opinions on different topics.

The presentation units or slides can be used for indexing and/or organizing a variety of information services. The presentation server 150 may maintain a database that links the presentation units with various data items that are related to each of the presentation units, such as questions, comments, audience IDs for the questions/comments, etc. For instance, the presentation server 150 may link the slides with questions in connection with each slide, student IDs of the students who asked the questions, professor's responses to the questions, and/or statistics of the slides like confusion levels. When the professor notices that the confusion level for a specific slide is high, the professor may retrieve the slide, review questions corresponding to that slide and provide answers thereto. The presentation server 150 may deliver the professor's answers to each question directly to the student who asked the question based on the student's ID linked to that slide and the question. The professor may also post a clarification attached to a particular presentation unit on the BBS or discussion forums. The posts may include the slide, the question and the professor's answers thereto. The presentation server 150 may link the particular slide with the questions as well as the professor's answers thereto on the database system. The posts may be accessible by students when they use the audience system 181 to access their notes. For instance, when a students sends a request to access his notes for the Computer Organization class, the presentation server 150 retrieves the notes and slides from the database system based on the student's ID and information related to the Computer Organization class. In addition, the presentation server 150 retrieves any post that are linked to the slides for the Computer Organization class and sends such post to the student.

The networked presentation system 10 may also provide students or professors with tools to conduct proactive information research. For example, the presenter system 110 and the audience systems 181 may be equipped with Watson, a proactive information retrieval software application developed by Northwestern University Information Technology Development Laboratory of Evanston, Ill. Watson monitors and extracts keywords from active tasks performed on the presenter system 110 and the audience system 181. Based on the keywords, Watson generates a set of queries that are believed to be relevant to the contents of the active tasks. Watson then controls the presenter system 110 and/or the audience systems 181 to send out the queries to various search engines, data depositories, databases, and the like to search for data relevant to the contents of the active tasks. The results are then sent back to the presenter system 110 and/or the audience systems 181.

In one embodiment, the presentation server 150 is also equipped with a proactive information retrieval system like Watson. Whenever the presentation server 150 is to deliver a slide, Watson on the presentation server 150 is initiated to retrieve information related to that slide. After information related to the slide is obtained, the presentation server 150 may send the slide to the audience systems along with the information retrieved by Watson. The presentation server 150 may save the retrieved information in the database system and link the retrieved information to that slide.

Thus, during the Computer Organization class, the professor and/or the students may use Watson to retrieve information related to the slides presented during the class. Whenever a slide is displayed, Watson analyzes the contents of the slide and obtains information related to that slide. The professor and/or the students may combine the information with the slide and/or the notes for that slide. The professor can even generate new slides based on the information provided by Watson.

Software implementing the functions of the networked presentation system as described in this disclosure may be stored in a machine-readable storage medium, such as optical disks, hard disks, tapes, etc., and distributed to customers who want to use the networked presentation system. The software may also be distributed via the Internet. Customers may download the software from a web site and install the programs on their own systems.

The disclosure has been described with reference to specific embodiments thereof. It will, however, be evident that various modifications and changes may be made thereto without departing from the broader spirit and scope of the disclosure. The concepts described in the disclosure can apply to various operations of the networked presentation system without departing from the concepts. The specification and drawings are, accordingly, to be regarded in an illustrative rather than a restrictive sense.

What is claimed is:

1. A method for controlling synchrony of presentation units on a presenter system and an audience system comprising the steps of:
constantly receiving a signal specifying one of the presentation units being rendered active on the presenter system;
accessing the one of the presentation units being rendered active on the presenter system; and
delivering the one of the presentation units being rendered active on the presenter system to the audience system.

2. The method of claim 1 further comprising the steps of:
maintaining a presentation sequence of the presentation units based on the signal specifying one of the presentation units being rendered active on the presenter system; and
continuously conveying the presentation sequence of the presentation units to the audience system.

3. The method of claim 2 further comprising the steps of:
generating a control signal based on the signal specifying the one of the presentation units being rendered active on the presenter system; and
sending the control signal to the audience system to update a presentation sequence maintained by the audience system.

4. The method of claim 1 further comprising the steps of:
receiving a status signal from the audience system identifying a presentation unit being displayed on the audience system;
comparing the presentation unit being displayed on the audience system with the one of the presentation units being displayed on the presenter system; and
in response to the presentation unit being displayed on the audience system being different from the one of the presentation units being displayed on the presenter system as determined in the comparing step, generating a control signal to control the audience system to present a link for accessing the presentation units being displayed on the presenter system.

5. The method of claim 1 further comprising the steps of:
receiving a status signal indicating that a presentation unit being displayed on the audience system is different from the one of the presentation units being displayed on the presenter system; and
generating a control signal to control the audience system to present a link for accessing the presentation units being displayed on the presenter system.

6. The method of claim 1 further comprising the steps of:
receiving a signal indicating another presentation unit being rendered active on the presentation system;
in response to the signal indicating another presentation unit being rendered active on the presentation system, accessing the another presentation unit; and
delivering the another presentation unit to the audience system.

7. The method of claim 1 further comprising the steps of:
receiving notes corresponding to a specific presentation unit sent from the audience system; and
storing the notes corresponding to the specific presentation unit.

8. The method of claim 7 further linking the notes to at least one of the following: an ID representing a user by whom the notes are created, an ID of a presentation, the time when the notes are taken, and a presentation unit ID of the specific presentation unit.

9. The method of claim 1 further comprising the steps of:
sending a questionnaire to a plurality of audience systems;
receiving responses to the questionnaire from the plurality of audience systems;
accumulating the responses to the questionnaire from the plurality of audience systems; and
calculating an index based on the responses collected in the accumulating step.

10. A method for controlling synchrony of presentation units on a presenter system and an audience system comprising the steps of:
continuously receiving a signal specifying one of the presentation units being rendered active on the presenter system;
receiving an inquiry signal from the audience system requesting information related to the one of the presentation units being rendered active on the presenter system;
generating a reporting signal notifying the audience system of the one of the presentation units being rendered active on the presenter system; and
generating a control signal to control the audience system to present a link to access the one of the presentation units being rendered active on the presenter system, if the presentation units being displayed on the presenter system being different from a presentation unit being rendered active on the audience system.

11. The method of claim 10 further comprising the steps of:
receiving a request to access the one of the presentation units being rendered active on the presenter system; and
delivering the one of the presentation units being rendered active on the presenter system to the audience system.

12. A method for controlling synchrony of presentation units on a presenter system and an audience system comprising the steps of:
continuously receiving a signal specifying one of the presentation units being rendered active on the presenter system;
receiving a signal from the audience system indicating a presentation unit being displayed on the audience system;
determining whether the one of the presentation units being rendered active on the presenter system is the same as the presentation unit being displayed on the audience system; and
generating a control signal to control the audience system to present a link to access the one of the presentation units being rendered active on the presenter system.

13. A machine-readable medium bearing instructions for controlling a data processing system for maintaining synchrony of presentation units on a presenter system and an audience system, the instructions upon execution by the data processing system causing the data processing system to perform the steps of:
continuously receiving a signal specifying one of the presentation units being rendered active on the presenter system;
accessing the one of the presentation units being rendered active on the presenter system; and
delivering the one of the presentation units being rendered active on the presenter system to the audience system.

14. A machine-readable medium bearing instructions for controlling a data processing system for maintaining synchrony of presentation units on a presenter system and an audience system, the instructions upon execution by the data processing system causing the data processing system to perform the steps of:
continuously receiving a signal specifying one of the presentation units being rendered active on the presenter system;
receiving a signal from the audience system indicating a presentation unit being displayed on the audience system;
determining whether the one of the presentation units being rendered active on the presenter system is the same as the presentation unit being displayed on the audience system; and
generating a control signal to control the audience system to present a link to access the one of the presentation units being rendered active on the presenter system.

15. A method for associating comments with presentation units comprising the steps of:
delivering the presentation units;
receiving comments in connection with one of the presentation units;
generating an association of the comments with the one of the presentation units; and
storing the comments and the association of the comments with the one of the presentation units.

16. The method of claim 15 further comprising the steps of:
receiving a request for accessing the comments;
accessing the association of the comments with the one of the presentation units;
retrieving the one of the presentation units based on the association; and
delivering the comments and the one of the presentation units.

17. The method of claim 16, wherein the comments and the one of the presentation units are configured to displayed on the same page.

18. The method of claim 15 further generating an association of the comments with a specific user who generates the comments.

19. The method of claim 18 further comprising the steps of:
receiving a request from the specific user to access the comments;
accessing the association of the comments with the one of the presentation units and the association of the comments with a specific user who generates the comments;
retrieving the one of the presentation units based on the association based on the association of the comments with the one of the presentation units and the association of the comments with a specific user who generates the comments; and
delivering the comments and the one of the presentation units.

20. The method of claim 18 further comprising the steps of:
receiving an indication allowing a user other than the specific user to access the comments;
generating an association of the comments in connection with the one of the presentation units with the user other than the specific user;
receiving a request to access the comments in connection with the one of the presentation units from the user other than the specific user;
in response to the request to access the comments in connection with the one of the presentation units from the user other than the specific user, retrieving the comments in connection with the one of the presentation units created by the specific user; and
delivering the comments in connection with the one of the presentation units crated by the specific user to the user other than the specific user.

21. The method of claim 18 further comprising the steps of:
receiving an indication from the specific user allowing a user other than the specific user to access comments created by the specific user on the condition that the user other than the specific user allows the specific user to access comments created by the user other than the specific user;
delivering to the user other than the specific user the indication allowing the user other than the specific user to access the comments created by the specific user on the condition that the user other than the specific user allows the specific user to access the comments created by the user other than the specific user;
receiving an indication from the user other than the specific user agreeing to allow the specific user to access the comments created by the user other than the specific user;
in response to the indication from the user other than the specific user agreeing to allow the specific user to access the comments created by the user other than the specific user, generating an association of the comments created by the specific user with the user other than the specific user;
receiving from the user other than the specific user a request to access the comments created by the user other than the specific user; and
in response to the request to access the comments created by the user other than the specific user, retrieving the comments in connection with the one of the presentation units created by the specific user;
delivering to the user other than the specific user the comments in connection with the one of the presentation units created by the specific user.

22. The method of claim 21 further comprising the steps of:
in response to the request to access the comments created by the user other than the specific user, retrieving the comments in connection with the one of the presentation units created by the user other than the specific user; and
delivering to the user other than the specific user the comments in connection with the one of the presentation units created by the user other than the specific user.

23. The method of claim 15, wherein the comments includes at least one of notes, questions and an indication of confusion corresponding to the one of the presentation units.

24. The method of claim 15 further comprising the steps of:
accumulating comments from a plurality of users in connection with the one of the presentation units;
receiving a request from a presenter system to access the comments or the presentation units; and
in response to the request, accessing the comments in connection with the one of the presentation units based on the association of the comments with the one of the presentation units; and
delivering the comments and the one of the presentation units based on the association of the comments with the one of the presentation units to the presenter.

25. The method of claim 24, wherein the comments includes at least one of notes, questions and an indication of confusion corresponding to the one of the presentation units.

26. The method of claim 15 further comprising the steps of:
calculating a number of comments sent by a plurality of users in connection with the one of the presentation units; and
generating an index related to the one of the presentation units based on the number of comments obtained in the calculating step.

27. The method of claim 15 further comprising the steps of:
accumulating comments from a plurality of users in connection with the one of the presentation units; and
calculating an index in connection with the one on the presentation units based on the comments obtained in the accumulating step.

28. The method of claim 27 further delivering the index to a presenter system.

29. The method of claim 1 further comprising the steps of:
retrieving contents of the one of the presentation units; and
retrieving information from at least one data depository based on the contents of the one of the presentation units.

30. The method of claim 29 further generating an association of the one of the presentation units with the information obtained in the retrieving information step.

31. The method of claim 29 further delivering the information obtained in the retrieving information step to the audience system.

32. The method of claim 18 further comprising the steps of:
receiving responses corresponding to the comments in connection with one of the presentation units;
generating an association of the responses with the one of the presentation units; and
delivering the comments, the responses and the one of the presentation units to the specific user who generates the comments.
